(19) United States
(12) Patent Application Publication
(10) Pub. No.: US 2025/0214037 A1
(43) Pub. Date: Jul. 3, 2025

(54) CARBON DIOXIDE SEQUESTRATION WITH MAGNESIUM HYDROXIDE AND REGENERATION OF MAGNESIUM HYDROXIDE

(71) Applicant: CARBONFREE CHEMICALS HOLDINGS, LLC, San Antonio, TX (US)

(72) Inventors: Joe JONES, San Antonio, TX (US); Al YABLONSKY, San Antonio, TX (US)

(73) Assignee: CARBONFREE CHEMICALS HOLDINGS, LLC, San Antonio, TX (US)

(21) Appl. No.: 19/005,499

(22) Filed: Dec. 30, 2024

Related U.S. Application Data
(63) Continuation of application No. 18/472,194, filed on Sep. 21, 2023, now Pat. No. 12,179,148.
Application No. 18/472,194 is a continuation of application No. 18/054,473, filed on Nov. 10, 2022, now Pat. No. 11,772,046.
Application No. 18/054,473 is a continuation of application No. 16/813,160, filed on Mar. 9, 2020, now Pat. No. 11,498,029.
Application No. 16/813,160 is a division of application No. 15/552,873, filed on Aug. 23, 2017, now Pat. No. 10,583,394.
(60) Provisional application No. 62/119,633, filed on Feb. 23, 2015.

(51) Int. Cl. B01D 53/96; B01D 53/62; B01D 53/73; B01D 53/78; C01B 7/03; C01F 5/00; C01F 5/14; C01F 5/24; C01F 5/32; C01F 11/18; F23J 15/00

(52) U.S. Cl. CPC B01D 53/96; B01D 53/62; B01D 53/73; B01D 53/78; C01B 7/035; C01F 5/00; C01F 5/14; C01F 5/24; C01F 5/32; C01F 11/18; F23J 15/006; B01D 2251/402; B01D 2251/604; B01D 2257/504; B01D 2258/0283; Y02C 20/40; Y02E 20/32; Y02P 20/129; Y02P 20/151

(57) ABSTRACT

Embodiments of the present disclosure are directed to systems and methods of removing carbon dioxide from a gaseous stream using magnesium hydroxide and then regenerating the magnesium hydroxide. In some embodiments, the systems and methods can further comprise using the waste heat from one or more gas streams to provide some or all of the heat needed to drive the reactions. In some embodiments, magnesium chloride is primarily in the form of magnesium chloride dihydrate and is fed to a decomposition reactor to generate magnesium hydroxychloride, which is in turn fed to a second decomposition reactor to generate magnesium hydroxide.

### CROSS REFERENCE TO RELATED APPLICATIONS

This application is a continuation application of U.S. Ser. No. 18/472,194 (now U.S. Pat. No. 12,179,148), filed Sep. 21, 2023, which is a continuation application of Ser. No. 18/054,473 (now U.S. Pat. No. 11,772,046), filed Nov. 10, 2022, which is a continuation of U.S. Ser. No. 16/813,160 (now U.S. Pat. No. 11,498,029), filed Mar. 9, 2020, which is a divisional of U.S. Ser. No. 15/552,873 (now U.S. Pat. No. 10,583,394), filed Aug. 23, 2017, which is a national phase under 35 U.S.C. § 371 of International Application No. PCT/US2016/019164, filed Feb. 23, 2016, which claims the benefit of priority to U.S. Provisional Patent Application Ser. No. 62/119,633, filed Feb. 23, 2015, the entire contents of each of which are hereby incorporated by reference in their entirety.

### A. FIELD OF THE INVENTION

The invention generally concerns devices, systems, and methods related to systems and processes of carbon sequestration with magnesium hydroxide and for regeneration of magnesium hydroxide from magnesium halide.

### B. BACKGROUND

Considerable domestic and international concern has been increasingly focused on the emission of CO₂ into the air. In particular, attention has been focused on the effect of this gas on the retention of solar heat in the atmosphere, producing the “greenhouse effect.” Although there is some debate regarding the magnitude of the effect, all would agree there is a benefit to removing CO₂ (and other chemicals) from point-emission sources, especially if the cost for doing so were sufficiently small.

Despite years of development, the task of creating a commercially-viable, environmentally-sensitive process for removing carbon dioxide from an emission source has proven to be a difficult. The methodologies to date have not been altogether satisfactory in this regard, and a significant need exists for the techniques described and claimed in this disclosure.

### SUMMARY

One aspect of the present disclosure is a system configured to regenerate Mg(OH)₂ and reduce the amount of CO₂ contained in a gas stream through consumption of the Mg(OH)₂. In some embodiments, the system can comprise: a first decomposition reactor configured to react MgCl₂ containing material with steam to form first reactor products comprising Mg(OH) Cl and HCl; a second decomposition reactor configured to react Mg(OH) Cl from the first decomposition reactor with steam to form HCl and magnesium-containing products comprising mostly Mg(OH)₂; and a first absorption reactor configured to form an admixture comprising Mg(OH)₂ from the second decomposition reactor, CO₂, CaCl₂, and steam to form products comprising MgCl₂ and CaCO₃. The MgCl₂ containing material fed to the first decomposition reactor can comprise a molar ratio of water to MgCl₂ of less than about 2.5:1. In some embodiments, the system can further comprise a gaseous feed line configured to pass a gaseous outflow from the second decomposition reactor to the first decomposition reactor, where the gaseous outflow comprises HCl and steam. In some embodiments, the system can further comprise a second absorption reactor, wherein the first absorption reactor is configured to admix Mg(OH)₂ from the second decomposition reactor with CO₂ contained in the gas stream and form MgCO₃ and H₂O and wherein the second absorption reactor is configured to admix the MgCO₃ from the first absorption reactor with CaCl₂) and form CaCO₃ and MgCl₂. In some embodiments, the first absorption reactor products are in a liquid phase and a solid phase, and the liquid phase is at least 50% by weight of MgCl₂. In some embodiments, the first absorption reactor (or the second absorption reactor if present) contains a liquid phase comprising a ratio of water to MgCl₂ of less than about 4.5:1 or about 4 to 1. In some embodiments, a major portion of MgCl₂ in the liquid phase that exits an absorption reactor is in the form of MgCl₂ tetrahydrate. In some embodiments, the system further comprises a solid liquid separator configured to separate at least a portion of the CaCO₃ from the liquid phase. In some embodiments, the system a dryer configured to remove a portion of the water from the liquid phase so the ratio of water to MgCl₂ is about 2 to 1. In some embodiments, a waste heat recovery and heat transfer system is utilized to provide the necessary heat to maintain reaction conditions for each system module.

Another aspect of the disclosure is a method of regenerating Mg(OH)₂ in a process that reduces the amount of CO₂ contained in a gas stream. In some embodiments, the method can comprise the following steps: (a) reacting MgCl₂-containing material with steam in a first admixture to form step (a) products comprising Mg(OH) Cl and HCl, where the MgCl₂ containing material comprises a water to MgCl₂ ratio of less than about 2.5:1; (b) reacting Mg(OH) Cl from step (a) with steam in a second admixture to form step (b) products comprising HCl and magnesium-containing products comprising mostly Mg(OH)₂; and (c) reacting Mg(OH)₂ from step (b) with CO₂, CaCl₂), and steam to form step (c) products comprising MgCl₂ and CaCO₃. In some embodiments, the method further comprises passing a gaseous outflow from the second admixture to the first admixture, where the gaseous outflow comprises HCl and steam to react with the MgCl₂ containing material. In some embodiments, step (c) can comprise a two stage process of admixing Mg(OH)₂ from step (b) with CO₂ contained in the gas stream in a third admixture to form first step (c) products comprising MgCO₃ and H₂O and admixing the MgCO₃ from first step (c) products with CaCl₂) in a fourth admixture to form a second step (c) products comprising CaCO₃ and MgCl₂. In some embodiments, the liquid phase of the first admixture is at least 50% by weight of MgCl₂. The method can further comprise the step or steps of separating at least a portion of the CaCO₃ and a portion of the water from the second step (c) products so that, in a remaining product, the ratio of water to MgCl₂ is about 2 to 1. In some embodiments, the first step (a) product comprises greater than 90% by weight of Mg(OH) Cl. In some embodiments, the first step (b) product comprises greater than 90% by weight of Mg(OH)₂. In some embodiments, the method can comprise recovering waste heat from a gas stream and transferring to the first admixture, the second admixture, and/or the remaining product comprising MgCl₂ dihydrate. In recovering and transferring the waste heat, three or more heating loops can be used.

Another aspect of the present disclosure is a method for producing magnesium hydroxide from magnesium chloride-containing material comprising: a first stage comprising the steps of introducing said material into a first reactor, passing a steam mixture into the first reactor with the magnesium chloride-containing material at the approximate temperature of 250 to 400° C., to form magnesium hydroxychloride and HCl, a second stage of conveying the magnesium hydroxychloride into a second reactor, introducing therewith steam to form magnesium hydroxide and HCl, where the magnesium chloride-containing material comprises a water to magnesium chloride ratio of about 2:1. In some embodiments, a portion of a steam mixture exiting the second reactor is the steam mixture introduced into the first reactor. At least a portion of the HCl exits the second reactor in the steam mixture that then passes through the first reactor. In some embodiments, the magnesium chloride-containing material substantially comprises magnesium chloride dihydrate. In some embodiments, waste heat is utilized to provide the heat necessary to form the Mg(OH)₂.

The terms “a” and “an” are defined as one or more unless this disclosure explicitly requires otherwise.

The terms “substantially,” “approximately” and “about” are defined as being largely but not necessarily wholly what is specified (and include wholly what is specified) as understood by one of ordinary skill in the art. In any disclosed embodiment, the term “substantially,” “approximately,” or “about” may be substituted with “within [a percentage] of what is specified, where the percentage includes 0.1, 1, 5, and 10 percent.

The terms “comprise” (and any form of comprise, such as “comprises” and “comprising”), “have” (and any form of have, such as “has” and “having”), “include” (and any form of include, such as “includes” and “including”) and “contain” (and any form of contain, such as “contains” and “containing”) are open-ended linking verbs. As a result, any of the present devices, systems, and methods that “comprises,” “has,” “includes” or “contains” one or more elements possesses those one or more elements, but is not limited to possessing only those one or more elements. Likewise, an element of a device, system, or method that “comprises,” “has,” “includes” or “contains” one or more features possesses those one or more features, but is not limited to possessing only those one or more features. Additionally, terms such as “first” and “second” are used only to differentiate structures or features, and not to limit the different structures or features to a particular order.

Furthermore, a structure that is capable performing a function or that is configured in a certain way is capable or configured in at least that way, but may also be capable or configured in ways that are not listed.

The feature or features of one embodiment may be applied to other embodiments, even though not described or illustrated, unless expressly prohibited by this disclosure or the nature of the embodiments.

Any of the present devices, systems, and methods can consist of or consist essentially of—rather than comprise/include/contain/have-any of the described elements and/or features and/or steps. Thus, in any of the claims, the term “consisting of” or “consisting essentially of” can be substituted for any of the open-ended linking verbs recited above, in order to change the scope of a given claim from what it would otherwise be using the open-ended linking verb.

Details associated with the embodiments described above and others are presented below.

### BRIEF DESCRIPTION OF THE DRAWINGS

The following drawings illustrate by way of example and not limitation. For the sake of brevity and clarity, every feature of a given structure may not be labeled in every figure in which that structure appears. Identical reference numbers do not necessarily indicate an identical structure. Rather, the same reference number may be used to indicate a similar feature or a feature with similar functionality, as may non-identical reference numbers.

FIG. 1 is a simplified process flow diagram according to some embodiments of the processes provided herein.

FIG. 2 is a simplified process flow diagram according to some embodiments of the processes provided herein.

FIG. 3 is a simplified process flow diagram according to some embodiments of the processes provided herein.

### DETAILED DESCRIPTION

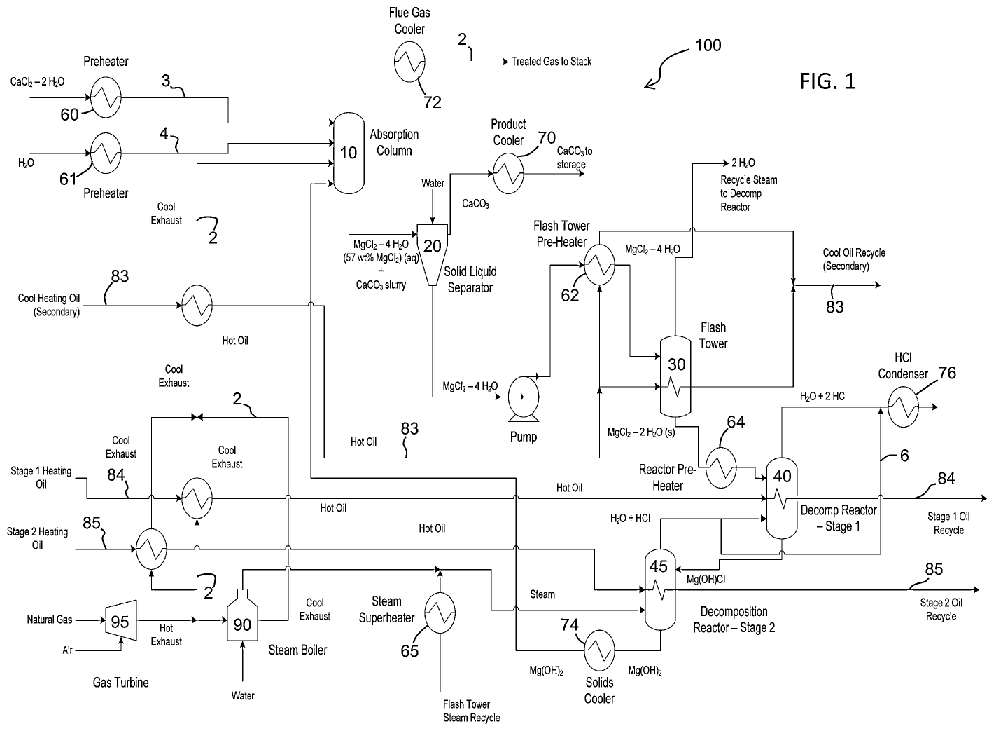

Referring to FIG. 1, shown therein and designated by the reference numeral 100 is a first embodiment of a system configured to remove from a gaseous stream using Mg(OH)₂ and to regenerate the Mg(OH)₂. System 100 is configured to absorb carbon dioxide from a gas stream 2 and regenerate at least one of the reactants, e.g., magnesium hydroxide, used in the absorption process. System 100 comprises an absorption reactor 10 configured to absorb CO₂ from a gaseous stream; a solid-liquid separator 20 configured to separate carbonate solids from aqueous magnesium chloride; a dryer 30 configured to remove a portion of water from the aqueous magnesium chloride forming magnesium chloride solids; a first decomposition reactor 40 configured to convert the magnesium chloride to magnesium hydroxychloride, and a second decomposition reactor 45 configured to convert the magnesium hydroxychloride to magnesium hydroxide. Also illustrated in system 100 is a plurality of heaters and heating fluid systems to elevate the temperatures of the different reactants.

Prior to treating the carbon dioxide containing gas stream 2, the temperature of gas stream 2 may be lowered. In the instance of a hot gas stream, (e.g., gas turbine exhaust), gas stream 2 can provide process heat that is transferred to different units in the system. In some embodiments, the process heat can be transferred to one or more of boilers, pre-heaters, reactors, or dryers 30 in the system. For example, in the embodiment shown, process heat can be transferred to a recycling heating fluid such as a hot oil system configured to provide indirect heating to the decomposition reactor. In some embodiments, process heat can be used to heat a boiler configured to generate superheated steam for direct steam injection into the decomposition reactor. In some embodiments, a second recycling heating fluid, such as a second hot oil system, is configured to provide indirect heating to dryer 30 to remove water from the MgCl₂ containing starting material.

After heat has been removed from gas stream 2, gas stream 2 enters absorption reactor 10 configured to react the CO₂ with CaCl₂) and Mg(OH)₂ via the following overall reactions:

CaCl₂+Mg(OH)₂+CO₂→CaCO₃+MgCl₂+H₂O (1)

Reactor 10 can be configured to receive CaCl₂) feed 3, gas stream 2, and a Mg(OH)₂ feed. In some embodiments, absorption reactor 10 is configured to operate at temperatures greater than 165° C., such as between about 170 to 250° C. In some embodiments, the operation temperature of reactor 10 can be at least 170, 175, 180, 185, 190, 195, 200, 210, 220, 230, or 240° C. In some embodiments, the operation temperature of reactor 10 is between 175 and 185° C. To maintain a temperature above the operation temperature, reactor 10 can be configured similar to a distillation column, with a water reflux entering the top of the column and a heat input at the bottom of the column to maintain a bottom liquid product at the operation temperature, such as about 175° C.

In some embodiments, the reactants can be preheated to the operation temperature prior to introducing into absorption reactor 10. For example, a calcium chloride feed 3 is preheated in heater 60 prior to being added to absorption reactor 10. In some embodiments, a water feed 4 may also be preheated in heater 61. As the reaction of CO₂ with hydroxide is exothermic, heat can be removed from reactor 10 to maintain operation temperature. In some embodiments, a circulating heating fluid loop (not shown) can be configured to transfer heat from reactor 10 to CaCl₂) feed 5, such as through heater 60. Similarly, a separate circulating heating fluid loop (not shown) can be configured to transfer heat from reactor 10 to water feed 4, such as through heater 61. By way of example, approximately 63 MMBtu/hr of process heat (such as from reactor 10) can be needed to heat 1,679 lb*mol/hr of CaCl₂*2H₂O solids from 25° C. to 175° C. and melt the solids at its melting point of 175° C., and to heat 1,679 lb*mol/hr of water from 25° C. to 100° C., vaporize the water, and superheat the steam to 175° C.

Calcium chloride can be added to reactor 10 in one of three forms to absorption reactor 10: anhydrous CaCl₂), CaCl₂*2H₂O, or CaCl₂*4H₂O. In some embodiments, a molar ratio of water to CaCl₂) of about 3:1 or less can be added to the absorption column for every mole of CO₂ that is captured. In some embodiments, CaCl₂)*2H₂O and water are fed to absorption reactor 10 to create an equivalent mixture of CaCl₂*3H₂O (67.2 wt % aqueous CaCl₂)). In some embodiments, CaCl₂) feed 3 in dihydrate form can be converted from a solid phase to a liquid phase prior to entering reactor 10.

Reactor 10 is configured to comprise an outlet for aqueous slurry of CaCO₃ solids in aqueous MgCl₂ and an outlet for gas stream 2 that contains a reduced amount of CO₂ than that inputted into reactor 10. In some embodiments, gas stream 2 with the reduced CO₂ concentration exits absorption reactor 10 and can then pass through gas cooler 72 where heat can be further recovered before gas stream 2 is exhausted to the atmosphere or further processed downstream. The heat can be used to pre-heat the reactants, such as CaCl₂) and optionally water. As a result of the absorption column, the amount of CO₂ in gas stream 2 can be reduced by at least 30%, 40%, 50%, 60%, 70%, 80%, 90%, 95%, 98%, or 99%.

In some embodiments, at least 50 wt % aqueous MgCl₂ exits absorption reactor 10 and enters solid-liquid separator 20, which separates the CaCO₃ solids from the aqueous solution. In some embodiments, a weight percent of aqueous MgCl₂ between 50 to 60% exits absorption reactor 10 and enters solid-liquid separator 20, such as 51%, 53%, 55%, 57%, or 59% wt MgCl₂. In some embodiments, a ratio of water to MgCl₂ in the aqueous solution is less than about 5 to 1, about 4.5 to 1, or about 4 to 1. In some embodiments, a major portion of MgCl₂ in the aqueous solution is in the form of MgCl₂ tetrahydrate.

In some embodiments, water may be added to solid-liquid separator 20 to facilitate the separation of the carbonate solids. In such embodiments, the amount of water to be added can dilute the solution by less than 30%, 25%, 20%, 15%, 10%, or 5%. Once separated, in some embodiments, the hot CaCO₃ solids can be passed through a cooler 70 for energy recovery before being sent to storage.

After separating the carbonate solids from the aqueous MgCl₂, the aqueous solution is transferred to dryer 30 to remove water from the solution. In some embodiments, a sufficient amount of water is evaporated from the solution so that the ratio of water to MgCl₂ is less than about 3:1, about 2.5:1, or less than about 2 to 1. In some embodiments, a major portion of the water in the magnesium chloride-containing material exiting dryer 30 is in the form of MgCl₂ dihydrate. For example, the magnesium chloride containing material comprises at least 55%, 60%, 65% 70%, 75% 80%, 85% 90%, 95%, or 98% of MgCl₂*2H₂O(s). The primary reaction in dryer 30 is provided below:

MgCl₂*4H₂O(1)→MgCl₂*2H₂O(s)+2H₂O(g) (2)

In some embodiments, to supply the needed energy to remove a portion of the water, heat can be supplied to the vessel to keep the operation temperature at between 150 to 250° C., such as 160, 170, 180, 190, 200, 210, 220, 230, or 240° C. In some embodiments, the temperature can be kept between 195 and 205° C. or 198 and 202° C. Dryer 30 is configured such that superheated steam (and potentially some HCl) exits the top of the vessel, while magnesium chloride containing material comprising dihydrate salts moves to first decomposition reactor 40. In some embodiments, operation pressures are at atmospheric pressure. In some embodiments, the superheated steam produced from dryer 30 can supply at least a portion of the steam required for decomposition reactors 40 and/or 45.

In some embodiments, the aqueous MgCl₂ solution is pumped through a heater 62 before entering dryer 30 to raise the temperature of the solution to substantially equal to the operation temperatures of dryer 30. In some embodiments, heat can be transferred to the solution at heater 62 by a circulating heating fluid loop 83 configured to transfer heat from gas stream 2 to the aqueous solution.

In some embodiments, system 100 comprises an evaporator 30 that is configured to reduce the water content so that MgCl₂ turns to solid and the solid material can be transferred to first decomposition reactor 40. For example, evaporator 30 can comprise a flash drum having a scraper or other agitator configured to facilitate conveyance to solid material. In some embodiments, in evaporator 30, a pressurized MgCl₂ solution at the operation temperature is flashed to atmospheric pressure to remove water from the aqueous solution and produce MgCl₂*2H₂O solids. In some embodiments, a portion of the heating fluid in circulating loop 83 may be directed to evaporator 30 to maintain the operation temperatures of evaporator 30.

In some embodiments, system 100 comprises a dryer 30 that is configured to reduce the water content so that aqueous MgCl₂ turns to solid and the solid material can be transferred to first decomposition reactor 40. Dryer 30 can be configured to apply indirect contact heating or direct contact heating using a medium such as air to maintain operation temperatures. For example, dryer 30 can be a rotary dryer, a flash dryer, or a spray dryer. In some embodiments, a portion of the heating fluid in circulating loop 83 may be directed to dryer 30 to maintain the operation temperatures of dryer 30 and may also be directed to blower to heat the drying medium such as air. Other embodiments, in lieu of dryer 30, system 100 can comprise a flaker, a crystallizer, or a priller configured to reduce the water content so that the molar ratio is about 2:1 and/or the MgCl₂ is mostly in a dihydrate form and can be transferred to first decomposition reactor 40.

By way of example, the heat input needed to raise the temperature of the aqueous solution to an operation temperature of 200° C. is approximately 7 MMBtu/hr. Further, also by way of example, the heat input needed to reduce the water content of an aqueous solution where the molar ratio of water is 4:1 is approximately 71 MMBtu/hr. For circulating heating fluid loop 83, the fluid return temperature can be about 5 to 15° C. above the operation temperature, e.g., 210° C., for the fluid leaving dryer 30 or heater 62. In addition, the fluid supply temperature (e.g., the temperature of the fluid approaching dryer 30 or heater 62) can be about 20 to 30° C. above the operation temperature or 10 to 20° C. above the return temperature, e.g., 225° C. At the intercept of loop 83 with gas stream 2, the temperature of gas stream 2 can be a temperature that is at least 30 to 40 above the operation temperature of decomposition reactor 40. In some embodiments, the temperature of gas stream 2 after transferring heat to loop 83 can be at least 235° C.

System 100 comprises reactors configured for a two stage, counter-current flow decomposition reactor to convert MgCl₂ to Mg(OH)₂. Within the first stage, reactor 40 is configured for the following reaction to occur:

MgCl₂*2H₂O(s)→Mg(OH)Cl(s)+HCl(g)+H₂O(g) (3)

Within the second stage, reactor 45 is configured for the following reaction to occur:

Mg(OH)Cl(s)+H₂O(g)→Mg(OH)₂(s)+HCl(g) (4)

In second reactor 45, steam can be counter-currently contacted with MgOHCl solids fed from first reactor 40. In some embodiments, steam can be generated by a boiler 90 that is heated by gas stream 2. Also, steam recycled from the exhaust of reactors 40 and 45 can be mixed with the steam from boiler 90 to feed reactor 45. Recycled steam may be heated by a heater 65 to obtain the desired final steam temperature to feed reactor 45. Steam is introduced into reactor 45 at a temperature that is substantially the same as the operation temperature of reactor 45 as described below. For example, steam can be introduced into reactor 45 at a temperature between 385° C. and 395° C., such as about 390° C.

The Mg(OH)₂ solids exiting reactor 45 are in equilibrium with the vapor leaving reactor 45. In some embodiments, the exiting vapor leaving reactor 45 will comprise at least 0.8 mole of HCl for every mole of Mg(OH)₂ produced. For example, the exiting vapor leaving reactor 45 can comprise 0.85 mole of HCl, 0.9 mole of HCl, 0.95 mole of HCl, 0.98 mole HCl for ever mole of Mg(OH)₂ produced. The rate of counter-flow through reactor 45 is sufficient to keep the partial pressure of HCl low enough so that reaction (5) equilibrium is shifted to the right. In some embodiments, the counter flow is 100% superheated steam. In other embodiments, the counter flow comprises superheated steam and an inert carrier gas. In some embodiment, the partial pressure of HCl can be maintained at a sufficiently low amount by operating the decomposition reaction 45 under vacuum conditions.

In reactor 40, the vapor mixture of superheated steam and HCl leaving reactor 45 is counter-currently contacted with the magnesium chloride material fed from dryer or evaporator 30 comprising MgCl₂*2H₂O solids. In some embodiments, only a portion of the steam exiting reactor 45 is fed to reactor 40. For example, a majority of the vapor exiting reactor 45 can bypass reactor 40 so that additional heat can be recovered in the HCl condenser 76. In some embodiments, the Mg(OH) Cl solids exiting reactor 40 are in equilibrium with the vapor leaving reactor 40. In some embodiments, the exiting vapor leaving reactor 40 will comprise at least an additional 0.8 mole of HCl for every mole of MgOHCl produced. For example, the exiting vapor leaving reactor 40 can comprise an additional 0.85 mole of HCl, 0.9 mole of HCl, 0.95 mole of HCl, 0.98 mole HCl for ever mole of MgOHCl produced. The rate of counter-flow through reactor 40 is sufficient to keep the partial pressure of HCl low enough to maintain a shift of reaction (4) to the right.

The operation temperature for reactor 45 can be between 380° C. and 500° C., such as about 390, 400, 410, 420, 430, 440, 450, 460, 470, or 490° C. In some embodiments, the operation temperature for reactor 45 is between about 385° C. and 395° C., such as about 390° C. The operation temperature for reactor 40 can be between 250° C. and 400° C., such as 260, 270, 280, 290, 300, 310, 320, 330, 340, 350, 360, 370, 380, or 390° C. In some embodiments, the operation temperature of reactor 40 is between about 275° C. and 285° C., such as about 280° C. By way of example, the steam requirements for the two-stage counter-current configuration can be approximately 8.6 lb/hr of steam per lb/hr HCl at 390° C. for second reactor 45 and 280° C. for first reactor 40.

An output of reactor 40 comprises solid MgOHCl. In some embodiments, the solid phase output of reactor 40 is at least 55%, 60%, 65% 70%, 75% 80%, 85% 90%, 95%, 98%, or 99% of MgOHCl. An output of reactor 45 comprises solid Mg(OH)₂. In some embodiments, the solid phase output of reactor 45 is at least 55%, 60%, 65% 70%, 75% 80%, 85% 90%, 95%, 98%, or 99% of Mg(OH)₂.

In some embodiments, to maintain operation temperatures of reactors 40 and 45, heat can be supplied to the decomposition reactors 40, 45 indirectly through a circulating heating fluid loop to keep the decomposition reactor at the desired temperature. For example, heating fluid jackets about each reactor 40 and 45 can facilitate maintenance of the operation temperature. In the embodiment shown, circulating heating fluid loop 84 is configured to transfer heat from gas stream 2 to reactor 40 and circulating heating fluid loop 85 is configured to transfer heat from gas stream 2 to reactor 45.

In some embodiments, the MgCl₂ containing material exiting dryer 30 can be conveyed through a heater 64 before entering reactor 40 to raise the temperature of the solution to substantially equal to the operation temperatures of reactor 40. In some embodiments, while not shown in the one illustrated, a portion of the heating fluid in circulating loop 84 may be directed to heater 64 to heat the MgCl₂ containing material fed to reactor 40.

In some embodiments, for circulating heating fluid loop 85, the fluid return temperature (e.g., for the heating fluid leaving reactor 45 and heater 65) can be about 5 to 15° C. above the operation temperature of reactor 40; e.g., the fluid return temperature can be about 400° C. In addition, the fluid supply temperature (e.g., the temperature of the fluid approaching reactor 45 and heater 65) can be about 10 to 45° C. above the operation temperature or 5 to 25° C. above the return temperature; e.g., the fluid supply temperature can be about 415° C. At the intercept of loop 85 with gas stream 2, the temperature of gas stream 2 can be greater than 500° C. or greater than 600° C., e.g., the temperature of a flue gas exhaust stream. In some embodiments, the temperature of gas stream 2 after transferring heat to loop 85 can be at least 10° C. higher than the temperature of the heating fluid approaching reactor 45.

In some embodiments, for circulating heating fluid loop 84, the fluid return temperature (e.g., the temperature of the heating fluid leaving reactor 40 or heater 64) can be about 5 to 15° C. above the operation temperature of reactor 45; e.g., the fluid return temperature can be about 290° C. In addition, the fluid supply temperature (e.g., the temperature of the fluid approaching reactor 40 or heater 64) can be about 5 to 20° C. above the operation temperature or 60 to 100° C. above the return temperature; e.g., the fluid supply temperature can be about 355° C. At the intercept of loop 84 with gas stream 2, the temperature of gas stream 2 can be greater than 500° C. or greater than 600° C., e.g., the temperature of a flue gas exhaust stream. In some embodiments, the temperature of gas stream 2 after transferring heat to loop 85 can be at least 10 degrees higher than the temperature of the heating fluid approaching reactor 40.

The hot Mg(OH)₂ solids exiting reactor 45 can be passed through a solids product cooler 74 before entering absorption reactor 10, while the vapor product exiting reactor 40 is combined with the vapor bypass 6 around reactor 40. The combined vapor stream passes through HCl condenser 76 before being pumped to an HCl product tank.

As evident from the operation temperatures of the decomposition reactor, there are significant enthalpy requirements for the decomposition reactor, namely, the reaction enthalpy for the decomposition of MgCl₂*2H₂O to Mg(OH)₂ and HCl and the superheated steam requirements for direct steam injection into the decomposition reactor. In some embodiments, system 100 can comprise a gas turbine or be configured to receive gas stream 2 produced from a gas turbine, such as a 60 MW gas turbine 95 in the embodiment shown. In some embodiments, the overall CO₂ capture rate can be greater than 70%, 80%, 90%, 95%, or greater than 99%.

In addition to a first gas turbine, system 100 can comprise a furnace (not shown) to burn supplemental natural gas, and use heat recovered from the flue gas at the flame temperature to provide additional heat for steam generation within system 100. In some embodiments, for a two-stage counter-current reactor, the total enthalpy requirement for the process can be about 175 MMBtu/hr. The heat available from 60 MW turbine exhaust gas is about 146 MMBtu/hr, leaving an overall deficiency of about 29 MMBtu/hr that would be required to achieve 100% CO₂ capture. Burning 1.4 MMSCFD of supplemental natural gas in a furnace can provide heat recovery from the flue gas of 44.9 MMBtu/hr. In some embodiments, an additional 16-17 MMBtu/hr of enthalpy would be required within system 100 to capture this additional CO₂. This results in a net enthalpy surplus that could be used to achieve 100% CO₂ capture. If this 1.4 MMSCFD of natural gas were instead fired in a turbine, 5.6 MW of additional electricity could be produced (relative to the 60 MW of electricity produced in the existing turbine).

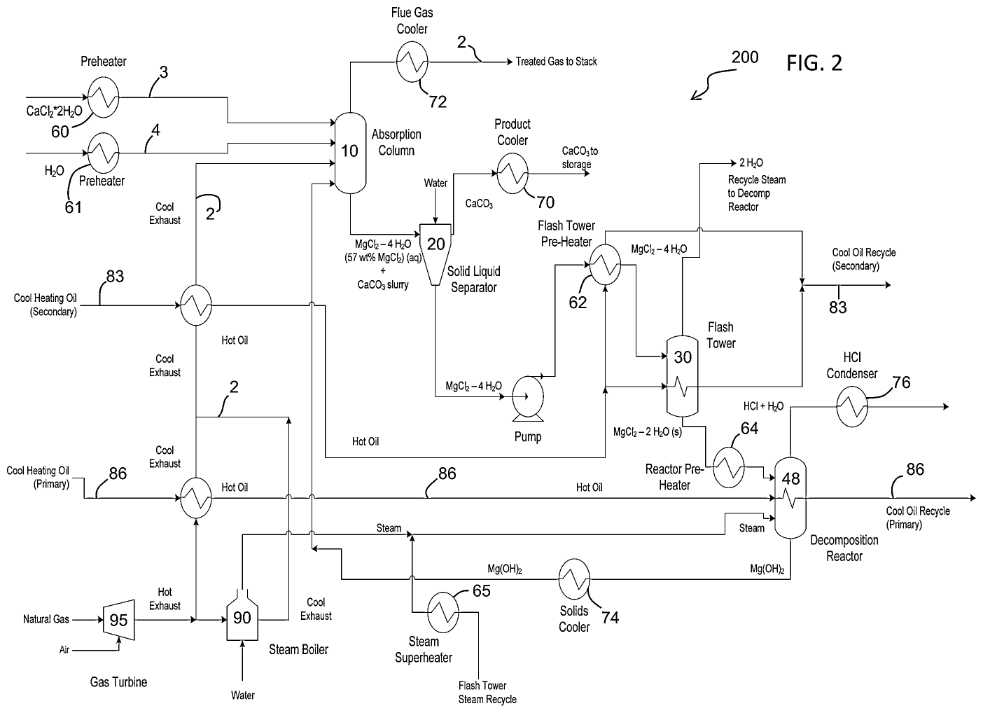

Referring now to FIG. 2, shown therein and designated by the reference numeral 200 is a second embodiment of a system configured to remove from a gaseous stream using Mg(OH)₂ and regenerate the Mg(OH)₂. Embodiment 200 is substantially similar to embodiment 100 described above, except that the decomposition process comprises only a single stage counter flow reactor 48 and circulating heating fluid loop 86 instead of loops 84 and 85. In some embodiments, the operation temperature of reactor 48 can be between 340° C.-360° C., such as 350° C. The superheated steam can be introduced at a temperature substantially the same as the operation temperature.

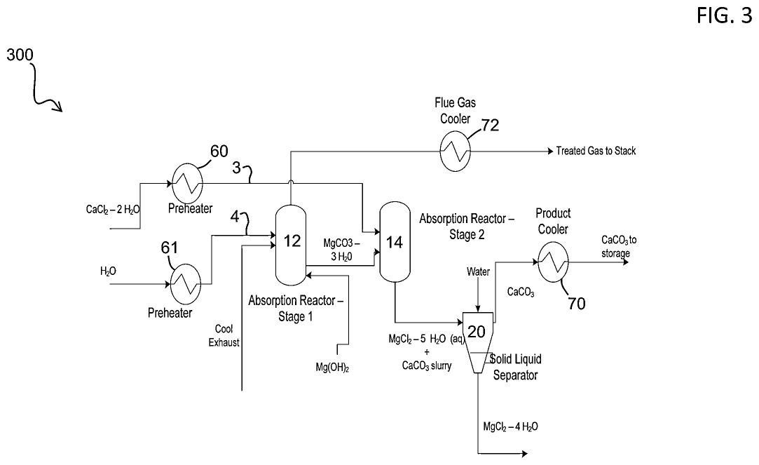

Referring now to FIG. 3, shown therein and designated by reference numeral 300 is an embodiment of a two-stage CO₂ absorption process that can be substituted for the one stage absorption process described above in connection with reactor 10. The two-stage process is substantially similar to the conditions described for the one-stage process except that two reactors are used instead of one and a slightly higher molar ratio of water to MgCl₂ is required. Within the first stage, reactor 12 is configured for the following reaction to occur:

Mg(OH)₂(s)+CO₂(g)→MgCO₃(aq)+H₂O(l) (5)

Within the second stage, reactor 14 is configured for the following reaction to occur:

CaCl₂(aq)+MgCO₃(aq)→CaCO₃(s)+MgCl₂(aq) (6)

In some embodiments, in reactor 12, the molar ratio of water to MgCO₃ can be about 3.5:1 or about 3:1. In some embodiments, in reactor 14, the molar ratio of water to MgCl₂ can be about 5.5:1 or about 5:1.

The above specification and examples provide a complete description of the structure and use of exemplary embodiments. Although certain embodiments have been described above with a certain degree of particularity, or with reference to one or more individual embodiments, those skilled in the art could make numerous alterations to the disclosed embodiments without departing from the scope of this invention. As such, the illustrative embodiments of the present systems and processes for removing carbon dioxide from a gaseous stream and regenerating magnesium hydroxide are not intended to be limiting. Rather, the present devices, systems, and methods include all modifications and alternatives falling within the scope of the claims, and embodiments other than those shown may include some or all of the features of the depicted embodiments. For example, components may be combined as a unitary structure and/or connections may be substituted. Further, where appropriate, aspects of any of the examples described above may be combined with aspects of any of the other examples described to form further examples having comparable or different properties and addressing the same or different problems. Similarly, it will be understood that the benefits and advantages described above may relate to one embodiment or may relate to several embodiments.

The claims are not to be interpreted as including means-plus- or step-plus-function limitations, unless such a limitation is explicitly recited in a given claim using the phrase(s) “means for” or “step for,” respectively.

1-43. (canceled)

44. A method of regenerating Mg(OH)₂ in a process that reduces the amount of CO₂ contained in a gas stream, comprising:
(a) reacting a MgCl₂ containing material with steam in a first decomposition reactor to form step (a) products comprising Mg(OH) Cl and HCl, where the MgCl₂ containing material comprises a water to MgCl₂ ratio of less than about 2.5:1;
(b) reacting the Mg(OH) Cl with steam in a second decomposition reactor to form step (b) products comprising HCl and magnesium-containing products comprising mostly Mg(OH)₂;
(c) reacting the Mg(OH)₂ with CO₂ in a first absorption reactor to form MgCO₃ and H₂O;
(d) reacting the MgCO₃ with CaCl₂ in a second absorption reactor to form step (d) products comprising MgCl₂ and CaCO₃.

45. The method of claim 44, wherein the step (a) products comprises greater than 90% by weight Mg(OH) Cl.

46. The method of claim 44, further comprising passing a gaseous outflow comprising HCl and steam from the second decomposition reactor to the first decomposition reactor.

47. The method of claim 44, wherein the magnesium chloride-containing material of step (a) comprises magnesium chloride dihydrate.

48. The method of claim 44, wherein a first decomposition reactor operation temperature ranges from 250° C. to 400° C.

49. The method of claim 44, wherein a second decomposition reactor operation temperature ranges from 380° C. to 500° C.

50. The method of claim 44, wherein the step (d) products are in a liquid phase and a solid phase, the liquid phase comprising an aqueous solution of at least 50% by weight of magnesium chloride.

51. The method of claim 50, wherein a solid phase step (d) product comprises calcium carbonate.

52. The method of claim 50, wherein a molar ratio of water to MgCl₂ in the step (d) products is 5 or less.

53. The method of claim 50, wherein a molar ratio of water to MgCl₂ in the step (d) products is less than 4.5 to 1.

54. The method of claim 50, further comprising separating at least a portion of the calcium carbonate formed in step (d) from the liquid phase in a solid liquid separator.

55. The method of claim 50, further comprising removing a portion of water from the liquid phase in a dryer to provide a product having a molar ratio of water to magnesium chloride of about 2 to 1.

56. The method of claim 55, wherein the dryer is configured to form magnesium chloride dihydrate.

57. The method of claim 56, further comprising employing the formed magnesium chloride dihydrate as the magnesium chloride-containing material of step (a).

58. The method of claim 44, further comprising transferring heat from the gas stream to a first recycling heating fluid and transferring heat from the first recycling heating fluid to the first decomposition reactor.

59. The method of claim 44, further comprising transferring heat from the gas stream to a second recycling heating fluid and transferring heat from the second recycling heating fluid to the second decomposition reactor.

60. The method of claim 50, further comprising transferring heat from the gas stream to a third recycling heating fluid and transferring heat from the third recycling heating fluid to the step (d) products to facilitate removal of water.
